(19) United States
(12) Patent Application Publication
(10) Pub. No.: US 2008/0148256 A1
(43) Pub. Date: Jun. 19, 2008

(54) HTTP Transaction Replay

(76) Inventors: Kenshi Doi, Yamato-shi (JP); Masaaki Ishibashi, Yamato-shi (JP); Makoto Kawai, Kawasaki-shi (JP); Nobuhide Matsuoka, Kanagawa-ken (JP); Kunio Okuda, Sagamihara-shi (JP); Kazuhiro Yabuta, Yamato-shi (JP)

Correspondence Address: LIEBERMAN & BRANDSDORFER, LLC, 802 STILL CREEK LANE, GAITHERSBURG, MD, 20878, US

(21) Appl. No.: 11/610,674

(22) Filed: Dec. 14, 2006

(51) Int. Cl. G06F 9/46

(52) U.S. Cl. 718/100

(57) ABSTRACT

A method and system are provided to replay an HTTP transaction that is comprised of multiple events. Each event is identified and organized based upon transaction of events over the course of time. The events of the transaction are replayed and organized into an order dependent relationship. The number of computations increases linearly with the number of events in the transaction.

### BACKGROUND OF THE INVENTION

1. Technical Field

This invention relates to a method and system for replaying an HTTP transaction using a recorded network trace. More specifically, the invention relates to evaluating a replayed HTTP transaction in order to place events within the HTTP transaction in an order dependent relationship.

2. Description of the Prior Art

Hypertext transfer protocol (HTTP) is a method used to transfer or convey information on a network of interconnected computer systems, including a local area network and a global area network. Each HTTP transaction includes an HTTP Request and a corresponding HTTP Response. FIG. 1 is a block diagram (100) showing a client machine (102) in communication with a server (120) across a network (130). The client machine includes a processor (104), memory (106), and a network adapter (108). Similarly, the server (120) includes a processor (124), memory (126), and a network adapter (128). An HTTP Request (150) originates with the client machine (102) and is sent to the server (120) in communication with the client machine (102). Similarly, an HTTP Response (160) originates with the server (120) and is sent to the client machine (102) in communication with the server (120). The HTTP Request (150) is the start event of the HTTP transaction, and the HTTP Response (160) is the concluding event of the HTTP transaction. Accordingly, the HTTP transaction is a request and response protocol between client machines and servers.

The originating client initiates a request by establishing a transmission control protocol (TCP) connection to a particular port on a remote host, e.g. server. An HTTP server listening on that specific port waits for the client to send a request message. Upon receiving the request, the server sends back a status line and a message of its own. In one embodiment, the communication sent to the client machine from the server is the HTTP Response.

From a user's perspective, a HTTP transaction consists of one HTTP Request, hereinafter Request, and a HTTP Response, hereinafter Response. A Request is active for the user, and a Response is passive for the user. However, many HTTP transactions are actually a compilation of multiple transactions, hereinafter referred to as a sub-transaction, with each sub-transaction having it's own Request and Response. For example, an HTTP transaction may include two sub-transactions, transaction_{A} and transaction_{B}, with each sub-transaction having it's own set of Requests and Responses, also known as events. FIG. 2 is a block diagram (200) showing a sample HTTP transaction (210) that includes two sub-transactions therein. The first sub-transaction, transactions, (202) has a Request_{A} (204) and a Response_{A} (206). Similarly, the second sub-transaction, transaction_{B}, (212) has a Request_{B} (214) and a Response_{B} (216). Most HTTP transactions have a requirement that the sub-transactions therein execute in a specified order so that if there is a dependency between the sub-transactions an error should not occur. For example, as shown in FIG. 2, there may be a requirement that transaction_{A} (202) should be completed before transaction_{B} (212) starts in order to avoid an error. More specifically, the HTTP Response_{A} (206) for transaction_{A} (202) should be received by the client machines before the HTTP Request_{B} (214) is executed and sent to the server. This alignment of sub-transactions is known as order dependent.

FIG. 3 is a flow chart (300) illustrating a prior art process to ensure that all sub-transactions in an HTTP transaction have been completed in proper order. The steps outlined herein utilize a replay tool to replay the HTTP transaction using a network trace. The person who is using the tool does not need to know the detail application logic or business logic in the HTTP transaction. Rather, the test tool replays the recorded sub-transactions while keeping order relations of the sub-transactions starts and ends, e.g. the HTTP Requests and associated HTTP Responses. The number of sub-transactions in the HTTP transaction is assigned the variable Nₜₒₜₐₗ (302), and the variable N defines a specific sub-transaction. Initially, the variable N is assigned the integer 1 (304). For each sub-transaction_{N} and when a scheduled event time is detected (306), the contextual information of the event_{N} is extracted (308) and the start conditions of a specific HTTP transaction_{N} are saved (310). Next, a determination is made as to whether the saved start conditions are met by the start time specified in the transaction scenario of the HTTP transaction (312). If the determination at step (312) is negative, the process returns to step (310) until the start conditions are met. Alternatively, if the determination at step (312) is positive, the request for the transaction_{N} is sent (314) and the request is recorded in the execution manager repository (316). Thereafter, when the response to the request is received (318), the response is recorded in the execution manager repository (320). Following step (320), the variable N is incremented (322), and a determination is conducted to determine if there are any more events in the transaction subject to evaluation (324). If the response to the determination at step (324) is positive, the process returns to step (306) for the next event in the transaction. Alternatively, if the response to the determination at step (324) is negative, the process is concluded.

The maximum number of computations required for judging the start conditions during execution of the entire test scenario is: N (N−1)/2, wherein N represents the total number of events in the HTTP transaction. The number of computations increases exponentially as the total number of events increases. Therefore, when the HTTP transactions of test scenarios are increased, the required resources for managing the replica execution order of HTTP events replication increases exponentially. Accordingly, there is a need for an HTTP replay tool that properly and efficiently replicates the events in the transaction in a set period of time, with fewer computations.

In addition, there is no tool that determines which events in an HTTP transaction are order relation dependent. If the sub-transactions in the HTTP transaction are completed out of order, an error may occur. Accordingly, in order to prevent an application error, there is a need to keep all events in a HTTP transaction in an order dependent relationship.

### SUMMARY OF THE INVENTION

This invention comprises a method and system for managing execution of an HTTP transaction.

In one aspect of the invention, a method is provided for managing execution order of events in an HTTP transaction. Each HTTP transaction includes at least one Request event and an associated Response event. All Request events and all Response events of the HTTP transaction are sorted in ascending order using recorded time. Following the sorting of the events, a number is assigned to each sorted event in the ascending order, and each of the assigned numbers is set as a state number for it's associated event. A state record is defined for each state number as a Boolean value, with each state record Boolean value initialized as false. The HTTP transaction is replayed. During the replay, the Boolean value to one of the state records associated with an active Request is set as true after execution of the active Request.

In another aspect of the invention, a computer system is provided with an HTTP server with a processor, and an HTTP transaction replay tool in communication with the HTTP server. The replay tool includes a director to manage execution order of an HTTP transaction. The director includes a sort manager to sort all HTTP Request events and all HTTP Response events in the HTTP transaction in ascending order using recorded time. In addition, the sort manager assigns a number to each sorted event in ascending order, and a state record manager sets each assigned number as state number for an associated event. The state record manager defines a state record for each state number as a Boolean value, and initializes each state record Boolean value as false. The replay tool replies to the HTTP transaction and sets a Boolean value to one of the state records associated with an active HTTP Request as true after execution of the HTTP Request.

In yet another aspect of the invention, an article is provided with an article having a tangible computer readable carrier including computer program instructions configured to cause a computer to manage execution order of HTTP transactions. Instructions are provided to sort all Request events and all Response events of an HTTP transaction in ascending order using recorded time. In addition, instructions are provided to assign a number to each sorted event in the ascending order, and to set each of the assigned numbers as a state number for an associated event. Instructions are also provided to define a state record for each state number as a Boolean value, and to initialize each state record Boolean value as false. In addition, instructions are provided to replay the HTTP transaction, including setting a Boolean value to one of said state records associated with an active HTTP Request as true after execution of the active HTTP Request.

Other features and advantages of this invention will become apparent from the following detailed description of the presently preferred embodiment of the invention, taken in conjunction with the accompanying drawings.

### BRIEF DESCRIPTION OF THE DRAWINGS

FIG. 1 is a block diagram of a prior art computer system configured to process a HTTP transaction.

FIG. 2 is a block diagram of a prior art of an example HTTP transaction.

FIG. 3 is a flow chart of a prior art process for managing execution order of events in an HTTP transaction.

FIGS. 4A and 4B are a flow chart illustrating a replay process for managing execution order of HTTP transaction events according to the preferred embodiment of this invention, and are suggested for printing on the first page of the issued patent.

FIG. 5 is a block diagram illustrating sorting of events using sorted time.

FIG. 6 is a block diagram illustrating assignment of status numbers to each Request and Response event in a HTTP transaction.

FIG. 7 is a block diagram of a two dimensional array for organizing events and associated state records.

FIG. 8 is a block diagram showing the two dimensional array of FIG. 7 at each event in the transaction example of FIG. 6.

FIG. 9 is a block diagram of the replay tool in a computer system.

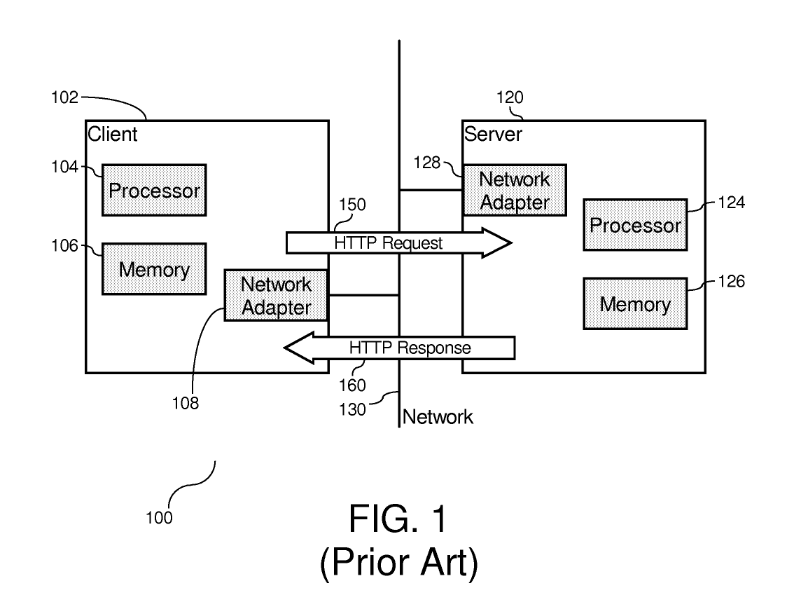

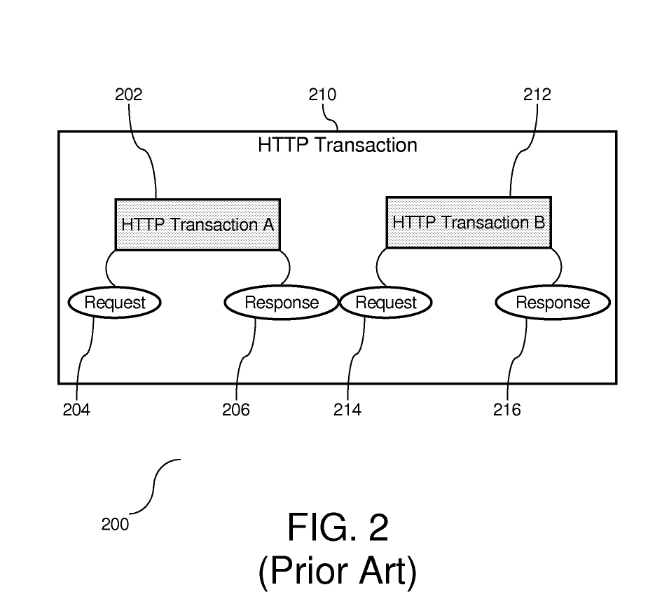

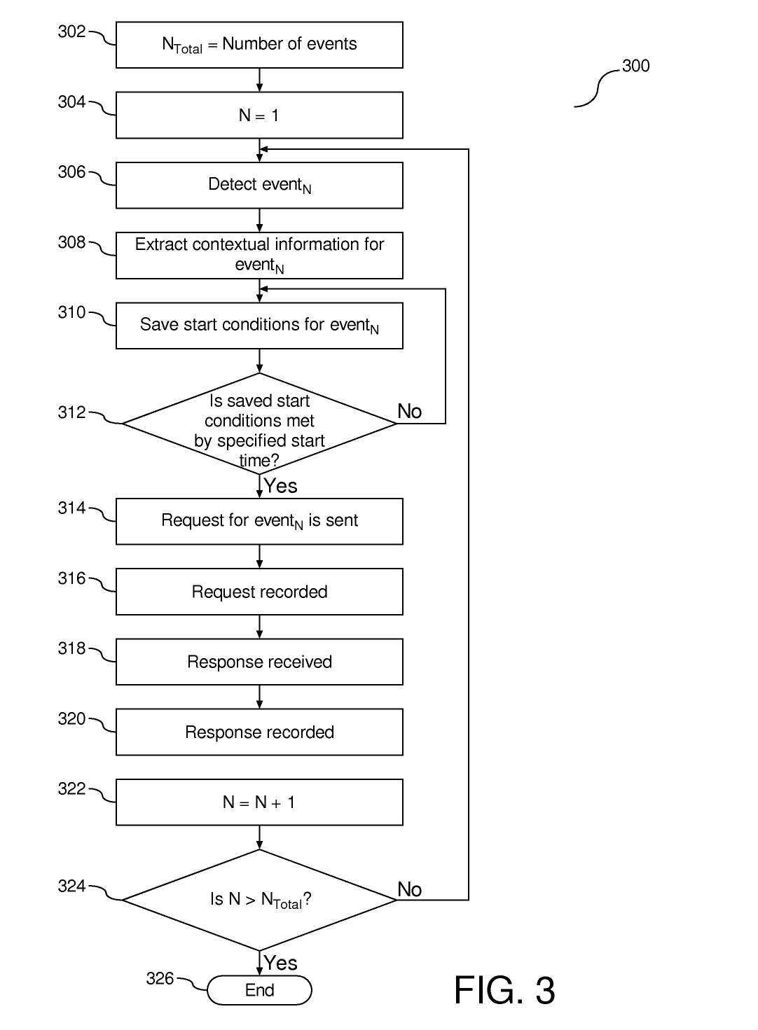

### DESCRIPTION OF THE PREFERRED EMBODIMENT

### Overview

A HTTP transaction includes at least one Request event and a corresponding Response event. Most HTTP transactions are comprised of a plurality of sub-transactions, with each sub-transaction having its own Request and Response events. In order for the HTTP transaction to properly perform, the events must execute in a proper order so that one sub-transaction does not initiate before a required prior sub-transaction is completed when the data submitted or produced by the prior sub-transaction is required for proper performance of the sub-transaction. Data submitted or produced by a prior transaction can originate with the server or the client.

### Technical Details

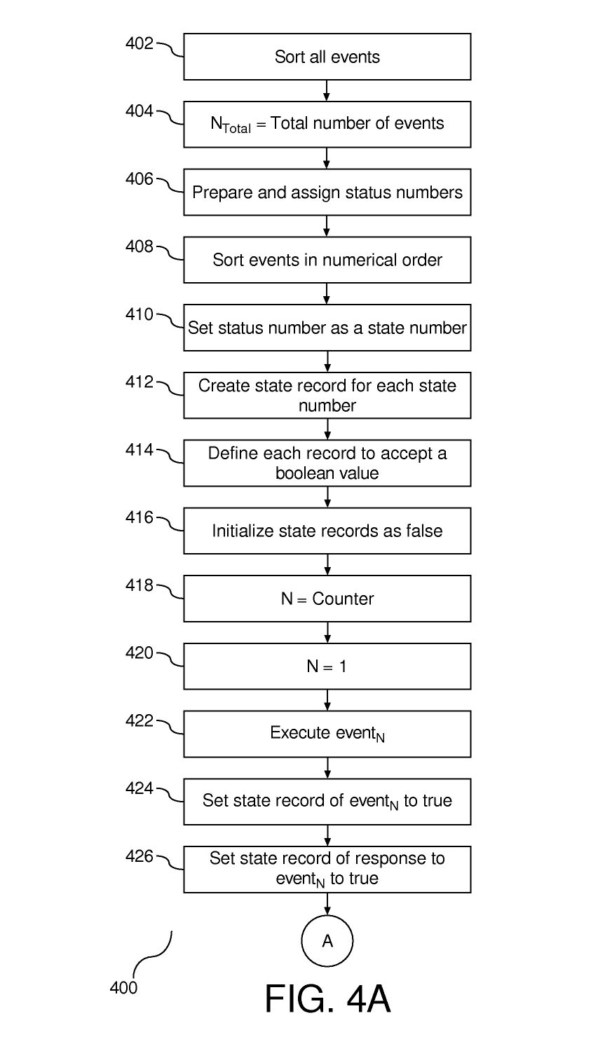

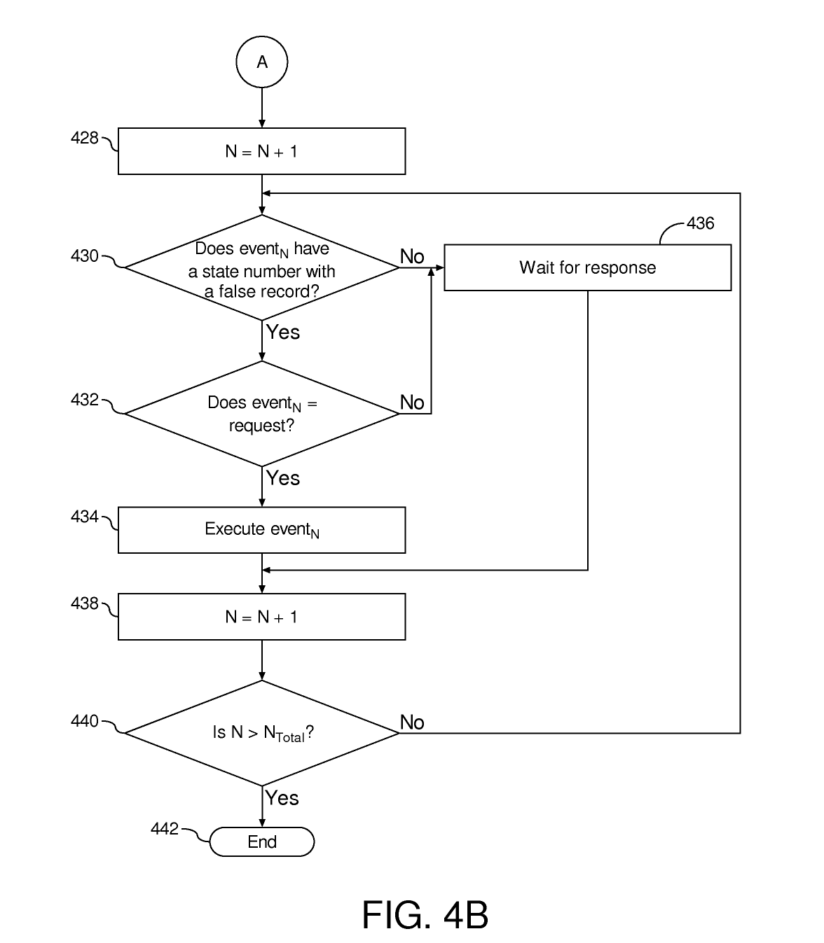

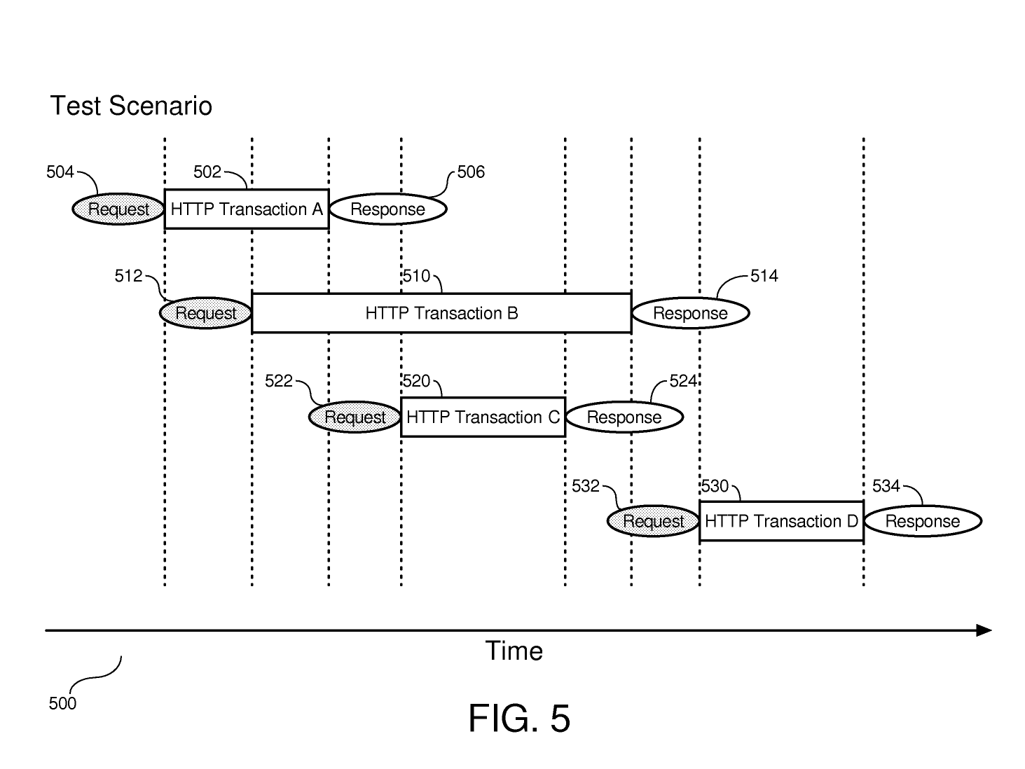

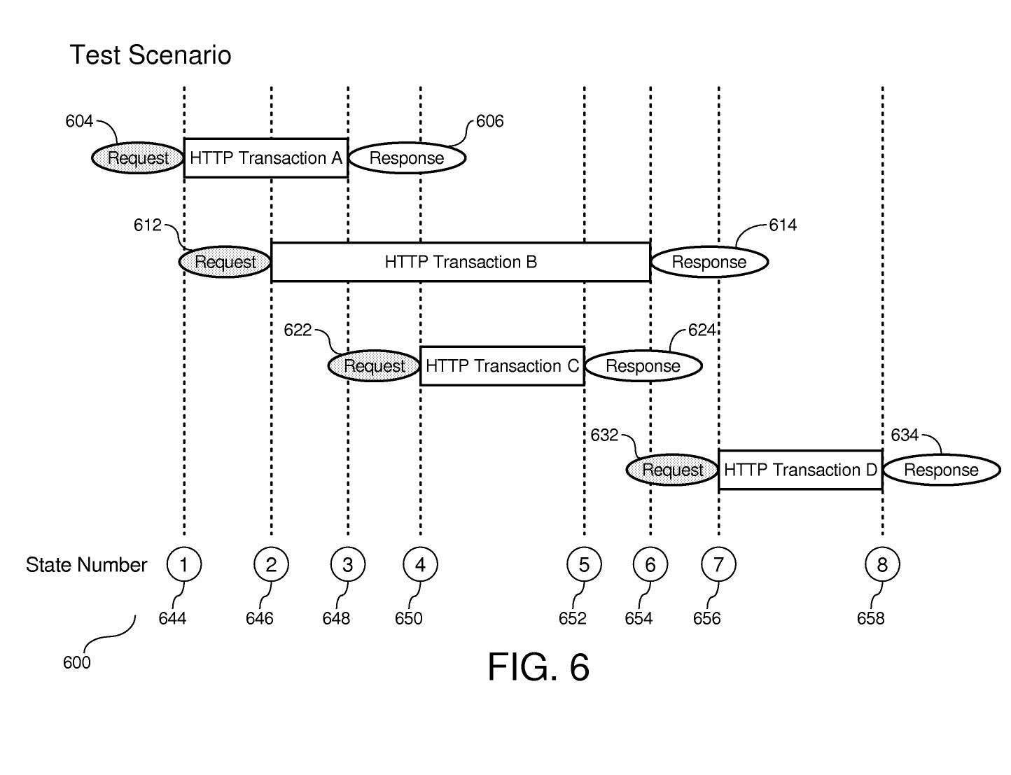

FIGS. 4A and 4B are a flow chart (400) illustrating a replay process for managing the execution order of an HTTP transaction having two or more sub-transactions. As noted above, each sub-transaction is comprised of a Request and a Response. The Request is the start event of the sub-transaction, and the HTTP Response is the concluding event of the sub-transaction. From the standpoint of the client machine, the Request is always active and the Response is always passive. Initially, all sub-transaction start and end events are sorted using recorded time (402). The variable Nₜₒₜₐₗ is defined as the total number of start and end events in the HTTP transaction (404). FIG. 5 is a block diagram (500) illustrating the process of sorting sub-transactions using sorted time. As shown, there are four sub-transactions, with each sub-transaction having it's own Request and Response. More specifically, transaction_{A} (502) has a Request (504) and a Response (506), transaction_{B} (510) has a Request (512) and a Response (514), transaction_{C} (520) has a Request (522) and a Response (524), and transaction_{D} (530) has a Request (532) and a Response (534). The transactions (502), (510), (520), and (530) are shown occurring over the course of time (540), shown herein on the horizontal axis. At step (402) all of the events, including each Request and Response in the HTTP transaction, are sorted by recorded time. There is no distinction provided between the Request and Response. Once each event in the sub-transactions has been sorted, a status number is prepared and assigned to each event based upon the sorted order of the transactions (406). The status numbers represent the start and end times for each Request and Response within the HTTP transaction. FIG. 6 is a block diagram (600) illustrating assignment of status numbers to each Request and Response of each sub-transaction shown in FIG. 5. As shown in FIG. 6, Request (604) is assigned status number one (644), Request (612) is assigned status number two (646), Response (606) is assigned status number three (648), Request (622) is assigned status number four (650), Response (624) is assigned status number five (652), Response (614) is assigned status number six (654), Request (632) is assigned status number seven (656), and Response (634) is assigned status number eight (658). Accordingly, the first part of the transaction management process includes assignment of status numbers to each event in ascending order of the events as they occur.

As shown in FIG. 6, the status numbers are assigned to the sub-transactions of an HTTP transaction. Following the assignment of numbers to each Request and Response in each sub-transaction, the assigned numbers and associated sub-transactions are sorted in numerical order (408), and each assigned number is set as a state number (410). Thereafter, a state record is created for each state number (412), and each state record is defined to accept a Boolean value of true or false (414). In one embodiment, the state record for all of the assigned status numbers may be represented in a one-dimensional array. Each of the state records is initialized as false (416). Accordingly, the second part of the transaction management process includes establishing a state record for each sub-transaction in the HTTP transaction.

The variable N is defined as a counter to track execution of a specific event in the HTTP transaction (418). Initially, the variable N is set to the integer one (420). The HTTP replay tool starts with the event_{N} of the sub-transaction_{N} and executes the Request actively (422). At the same time, the Boolean value of the state record of the event_{N} of the first sub-transaction is set to true after the tool executes the Request (424). As noted above, each transaction Request has a corresponding Response. However, the Response is accepted passively by the reply tool. Therefore, the Boolean value of the state record of the Response event_{N+1} is set to true after the tool accepts the Response (426). Following step (426), N is incremented (428). The state number of the next incremental event, N, which has a false state record and is the next event in the transaction. Therefore, a determination is made as to whether event_{N} has a corresponding state number with a Boolean value of false (430). If the response to the determination at step (430) is true and the corresponding event_{N} of the state number_{N} is a Request (432), the replay tool executes the request (434). Similarly, if the response to the determination at step (430) is negative and the corresponding event of the state number is a Response, the replay tool waits for receipt of the Response (436). Following steps (434) or (436), the variable N is incremented (438), and a determination is made as to whether the variable N exceeds the quantity of events in the HTTP transaction (440). If the response to the determination is negative, the process returns to step (430). However, if the response to the determination at step (442) is positive, the replay tool is completed.

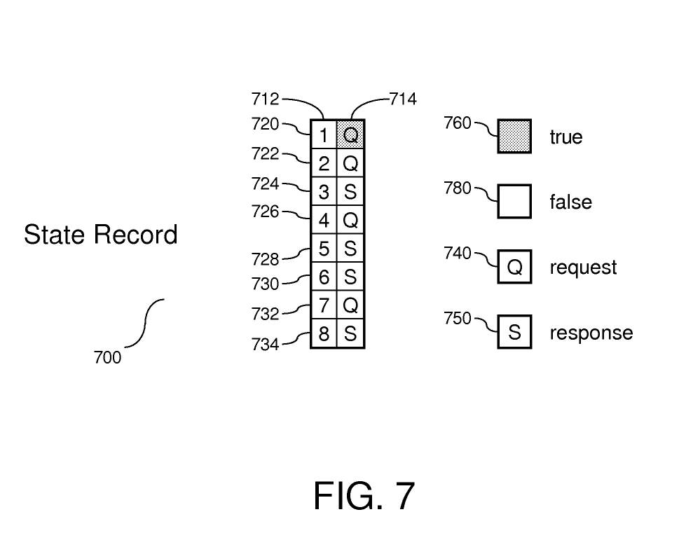

FIG. 7 is a block diagram (700) of a two dimensional array (710) with two columns (712) and (714) and a plurality of rows (720)-(734). The array is a representation of the HTTP transaction and assigned state numbers shown in FIG. 6. The first column (712) represents each event in the HTTP transaction, and the second column (714) represents the events classified as a Request or a Response. In this example, “Q” represents a Request (740) and “S” represents a Response (750). However, different indicia may be used to indicate the character of the event. Each event (720)-(734) in the second column (714) can have one of two Boolean values. In one embodiment, the Boolean value of true is shown darkened (760) and the Boolean value of false is shown in a transparent color (780). However, different indicia or colors may be used to indicate the Boolean value of each state record (720)-(734).

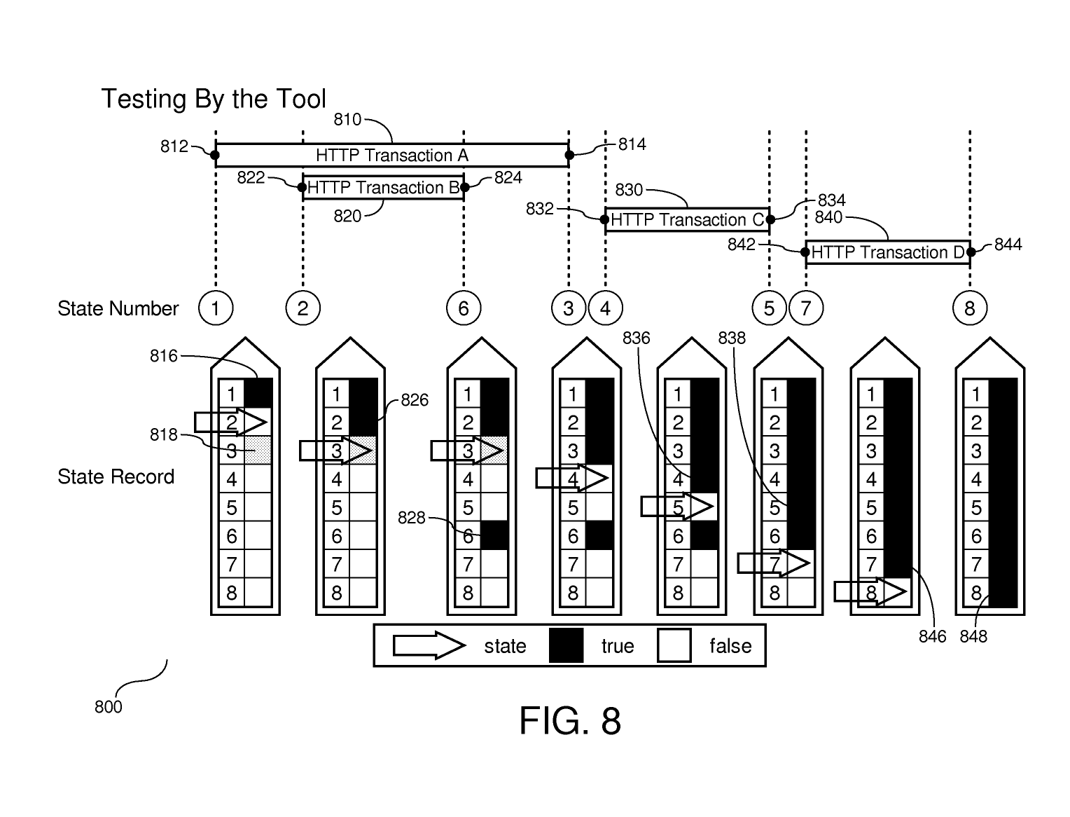

FIG. 8 is a block diagram (800) showing the two dimensional array of FIG. 7 at each event in the transaction example of FIG. 6. The HTTP transaction includes four sub-transactions, transaction_{A} (810), transaction_{B} (820), transaction_{C} (840), and transaction_{D} (860). Each transaction (810), (820), (830), and (840), has two events, a Request and a Response. As such, transaction_{A} (810) has a Request (812) and a Response (814), transaction_{B} (820) has a Request (822) and a Response (824), transaction_{C} (830) has a Request (832) and a Response (834), and transaction_{D} (840) has a Request (842) and a Response (844). Each event in the HTTP transaction has a replica of the two dimensional state number array. When the replay tool is activated, the first event in (812) in the HTTP transaction is executed and the associated state variable is set to true in the array, as shown at (816). The value of the state record of the response associated with the executed event is set to true after the replay tool accepts the response. This is shown at (818) by setting the state record of the response to false. As noted above, the minimum state record with a Boolean value of false is the next state record. In this example, the next state record with a Boolean value of false is the Request (822) of transactions (820). As reflected at (826), the state record of the Request (822) is changed to true upon execution of the associated Request, and the state record of the Response (828) is set to true. Thereafter, the next minimum state record with a Boolean value of false is the state record associated with the Request (832) of transaction_{C} (830). When the Request (832) is executed, the value of the associated state record is set to true as shown at (836). Thereafter, the associated Response (834) of transaction_{C} (830) is set to true (838). The next minimum state record with a Boolean value of false is the state record associated with the Request (842) of transaction_{D} (840). In this example, this is the final transaction of the HTTP transaction. The associated state record is set to true as shown at (846), followed by setting the state record reflective of the Response (844) of transaction_{D} (840) to true (848).

In the existing method of organizing the sub-transactions, the end of transaction_{A} (810) and the start of transaction_{B} (820) become the start conditions for transaction_{C} (830). Therefore, it is necessary to make judgments on all of these conditions at the scheduled start time of transaction_{C} (830). Having the state record of false for the start of transaction_{C} (830) be the minimum state record in the HTTP transaction is the only start condition for transaction_{C} (830). Accordingly, there is no requirement to retrieve the status of each event for each sub-transaction in the HTTP transaction before proceeding to the next event of the HTTP transaction.

In one embodiment, the invention is implemented in software, which includes but is not limited to firmware, resident software, microcode, etc. The invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

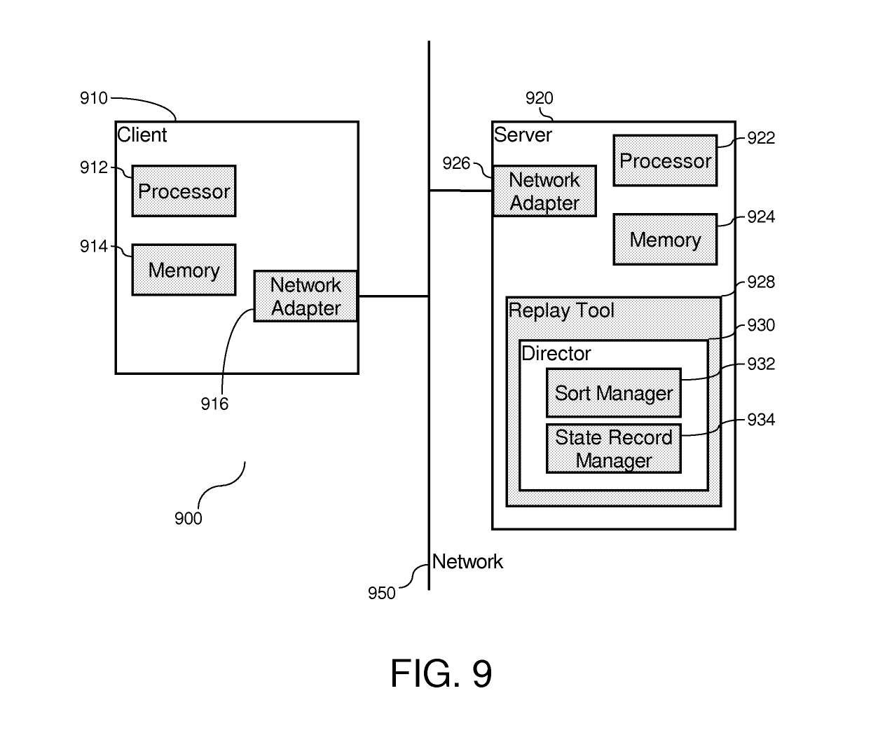

FIG. 9 is a block diagram (900) illustrating a client machine (910) in communication with a server (920) across a network (950). The client machine includes a processor (912), memory (914), and a network adapter (916). The server machine includes a processor (922), memory (924), a network adapter (926), and a replay tool (928). The server (920) is configured to accept HTTP formatted communications. The replay tool (928) of the server (920) is configured to accept HTTP transactions, such as an HTTP Request, and to communicate to the client (910) a corresponding HTTP Response. The replay tool includes a director (930) to manage execution order of the HTTP transaction. The director employs a sort manager (932) to sort all Request and Response events in an HTTP transaction in accordance with recorded time. In one embodiment, the transactions are sorted in ascending order. However, an alternative sorting order may be employed. The sort manager (932) is also responsible for assigning a number to each sorted event based upon the order employed for the sorting. The director (930) also employs a state record manager (934) to set each assigned number as a state number for an associated event. The state record manager (934) defines a state record for each state number as a Boolean value and initializes each state record Boolean value as false. The replay tool replies to the HTTP transaction and sets a Boolean value to one of the state records associated with an active HTTP Request as true after execution of the HTTP Request. As shown herein, the replay tool and the associated director and managers are hardware elements within the server. However, in one embodiment, the replay tool and associated director and managers may be software elements that reside within memory (924) of the server (920).

Embodiments within the scope of the present invention also include articles of manufacture comprising program storage means having encoded therein program code. Such program storage means can be any available media which can be accessed by a general purpose or special purpose computer. By way of example, and not limitation, such program storage means can include RAM, ROM, EEPROM, CD-ROM, or other optical disk storage, magnetic disk storage or other magnetic storage devices, or any other medium which can be used to store the desired program code means and which can be accessed by a general purpose or special purpose computer. Combinations of the above should also be included in the scope of the program storage means.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, random access memory (RAM), read-only memory (ROM), a rigid magnetic disk, and an optical disk. Current examples of optical disks include compact disk B read only (CD-ROM), compact disk B read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, wireless and Ethernet adapters are just a few of the currently available types of network adapters.

### ADVANTAGES OVER THE PRIOR ART

It has become possible to store an enormous number of HTTP transaction status numbers in a one-dimensional array. This supports retrieval of the overall execution status without performing complex computations to execute HTTP Requests in the HTTP transaction. There is only N number of start condition judgments, where N represents the number of events in an HTTP transaction. This reduces the number of computations required to determine whether the saved start conditions are met by the start time specified in a transaction scenario, regardless of the quantity of sub-transactions in the HTTP transaction. Accordingly, this supports a reduction in the use of resources needed for controlling the execution order of HTTP transaction replay to ensure the consistency of the test target application.

### ALTERNATIVE EMBODIMENTS

It will be appreciated that, although specific embodiments of the invention have been described herein for purposes of illustration, various modifications may be made without departing from the spirit and scope of the invention. In particular, the invention should not be limited to an array used to store the state number and associated record. In one embodiment, a data structure or other form of data arrangement and organization may be employed to track the state numbers and associated state records in an HTTP transaction. Accordingly, the scope of protection of this invention is limited only by the following claims and their equivalents.

We claim:

1. A method for managing execution order of HTTP transactions, comprising:
sorting all request events and all response events of an HTTP transaction in ascending order using recorded time;
assigning a number to each sorted event in said ascending order;
setting each of said assigned numbers as a state number for an associated event;
defining a state record for each state number as a Boolean value;
initializing each state record Boolean value as false;
replaying said HTTP transaction, including setting a Boolean value to one of said state records associated with an active HTTP Request as true after execution of said active HTTP request.

2. The method of claim 1, further comprising setting a Boolean value of true to an HTTP Response corresponding to said executed HTTP Request after said HTTP Response has been accepted.

3. The method of claim 2, further comprising assigning a minimum state number with a false state record as a current event in said replaying HTTP transaction.

4. The method of claim 3, further comprising executing said current event if said event is an HTTP Request.

5. The method of claim 3, further comprising pausing execution of a transaction of said current event if said transaction is an HTTP Response.

6. The method of claim 1, wherein a quantity of start condition judgments is a total of a quantity of request and response events in the HTTP transaction.

7. A computer system comprising:
an HTTP server with a processor;
an HTTP transaction replay tool in communication with said HTTP server;
said replay tool comprising a director to manage execution order of an HTTP transaction, said director comprising:
a sort manager to sort all HTTP Request events and all HTTP Response events in said HTTP transaction in ascending order using recorded time;
said sort manager to assign a number to each sorted event in ascending order;
a state record manager to set each assigned number as state number for an associated event; and
said state record manager to define a state record for each state number as a Boolean value, and to initialize each state record Boolean value as false;
said replay tool to reply said HTTP transaction and to set a Boolean value to one of said state records associated with an active HTTP Request as true after execution of said HTTP Request.

8. The system of claim 7, further comprising said replay tool to set a Boolean value of true to an HTTP Response that correspond to the executed HTTP Request after said HTTP Response has been accepted.

9. The system of claim 8, further comprising said replay tool to assign to a minimum state number with a false state record as a current event in said replay HTTP transaction.

10. The system of claim 9, further comprising said replay tool to execute said current event if said event is an HTTP Request.

11. The system of claim 9, further comprising said replay tool to pause execution of a transaction of said current event if said transaction is an HTTP Response.

12. The system of claim 7, further comprising a quantity of start condition judgments being a total of a quantity of request and response events in the HTTP transaction.

13. An article comprising:
a tangible computer readable carrier including computer program instructions configured to cause a computer to manage execution order of HTTP transactions, comprising:
instructions to sort all request events and all response events of an HTTP transaction in ascending order using recorded time;
instructions to assign a number to each sorted event in said ascending order;
instructions to set each of said assigned numbers as a state number for an associated event;
instructions to define a state record for each state number as a Boolean value;
instructions to initialize each state record Boolean value as false; and
instructions to replay said HTTP transaction, including setting a Boolean value to one of said state records associated with an active HTTP Request as true after execution of said active HTTP request.

14. The article of claim 13, further comprising instructions to set a Boolean value of true to an HTTP Response corresponding to said executed HTTP Request after said HTTP Response has been accepted.

15. The article of claim 14, further comprising instructions to assign a minimum state number with a false state record as a current event in said replay of said HTTP transaction.

16. The article of claim 15, further comprising instructions to execute said current event if said event is an HTTP Request.

17. The article of claim 15, further comprising instructions to pause execution of a transaction of said current event if said transaction is an HTTP Response.

18. The article of claim 13, further comprising a quantity of start condition judgments being a total of a quantity of request and response events in the HTTP transaction.
